(19) United States
(12) Patent Application Publication
(10) Pub. No.: US 2026/0004498 A1
(43) Pub. Date: Jan. 1, 2026

(54) VIDEO GENERATION METHOD, APPARATUS, AND ELECTRONIC DEVICE

(71) Applicant: Beijing Zitiao Network Technology Co., Ltd., Beijing (CN)

(72) Inventors: Liyu LIANG, Beijing (CN); Can LI, Beijing (CN); Kaibo CHU, Beijing (CN)

(21) Appl. No.: 19/245,699

(22) Filed: Jun. 23, 2025

(30) Foreign Application Priority Data
Jun. 27, 2024 (CN) 202410853000.X

(51) Int. Cl. G06T 13/40; G06F 40/166; G06T 11/60; G06T 13/80

(52) U.S. Cl. CPC G06T 13/40; G06F 40/166; G06T 11/60; G06T 13/80

(57) ABSTRACT

A video generation method comprises: obtaining a first video editing draft and an identifier of a target user, wherein the first video editing draft includes path information of a first multimedia resource and a first text field for video editing; determining, according to the first video editing draft and the identifier of the target user, a first file including path information of a second multimedia resource associated with the target user and a second file including a second text field associated with the target user; replacing, according to the first file, the path information of the first multimedia resource with the path information of the second multimedia resource, and replacing, according to the second file, the first text field with the second text field, so as to obtain a second video editing draft; and generating, according to the second video editing draft, a video associated with the target user.

### CROSS-REFERENCE TO RELATED APPLICATION(S)

This application claims priority to Chinese Application No. 202410853000.X filed in Jun. 27, 2024, the disclosures of which are incorporated herein by reference in their entirety.

### FIELD

The present disclosure relates to the field of video processing techniques, in particular to a video generation method, an apparatus, and an electronic device.

### BACKGROUND

A file may store video editing parameters and corresponding paths of multimedia resources used for video editing. A terminal device may obtain an edited video through the file.

A file for generating a video is now obtained through manual editing. For example, a user may edit one json file which may include video editing parameters added by the user and path information of multimedia resources.

### SUMMARY

The present disclosure provides a video generation method, an apparatus, and an electronic device.

In a first aspect, the present disclosure provides a video generation method, comprising:
obtaining a first video editing draft and an identifier of a target user, wherein the first video editing draft includes path information of a first multimedia resource and a first text field for video editing;
determining, according to the first video editing draft and the identifier of the target user, a first file including path information of a second multimedia resource associated with the target user and a second file including a second text field associated with the target user;
replacing, according to the first file, the path information of the first multimedia resource with the path information of the second multimedia resource, and replacing, according to the second file, the first text field with the second text field, so as to obtain a second video editing draft;
generating, according to the second video editing draft, a video associated with the target user.

In a second aspect, the present disclosure provides a video generation apparatus, comprising an obtaining module, a determining module, a replacing module and a generating module, wherein:
the obtaining module is provided for obtaining a first video editing draft and an identifier of a target user, wherein the first video editing draft includes path information of a first multimedia resource and a first text field for video editing;
the determining module is provided for determining, according to the first video editing draft and the identifier of the target user, a first file including path information of a second multimedia resource associated with the target user and a second file including a second text field associated with the target user;
the replacing module is provided for replacing, according to the first file, the path information of the first multimedia resource with the path information of the second multimedia resource, and replacing, according to the second file, the first text field with the second text field, so as to obtain a second video editing draft;
the generating module is provided for generating, according to the second video editing draft, a video associated with the target user.

In a third aspect, embodiments of the present disclosure provide an electronic device: comprising: a processor and a memory;
where the memory stores computer-executable instructions;
the processor executes the computer-executable instructions stored in the memory, such that the at least one processor performs the video generation method according to the above first aspect and various methods for image processing related to the above first aspect.

In a fourth aspect, embodiments of the present disclosure provide a computer-readable storage medium characterized in that the computer-readable storage medium is stored with computer-executable instructions, which computer-executable instructions, when executed by a processor, implement the video generation method according to the above first aspect and various methods for image processing related to the above first aspect.

The present disclosure provides a video generation method, an apparatus, and an electronic device. The electronic device may obtain a first video editing draft and an identifier of a target user, wherein the first video editing draft includes path information of a first multimedia resource and a first text field for video editing. The electronic device may determine, according to the first video editing draft and the identifier of the target user, a first file and a second file, wherein the first file includes path information of a second multimedia resource associated with the target user and the second file includes a second text field associated with the target user. The electronic device may replace, according to the first file, the path information of the first multimedia resource with the path information of the second multimedia resource, and replace, according to the second file, the first text field with the second text field, so as to obtain a second video editing draft. The electronic device may generate, according to the second video editing draft, a video associated with the target user.

### BRIEF DESCRIPTION OF THE DRAWINGS

Brief introduction of the drawings required in the following description of the embodiments or the prior art are to be provided below to more clearly explain the technical solutions according to the embodiments of the present disclosure or in the prior art. It is obvious that the following drawings illustrate some embodiments of the present disclosure and those skilled in the art also may obtain other drawings on the basis those illustrated ones without any exercises of inventive work.

FIG. 1 illustrates a schematic diagram of an application scenario provided by embodiments of the present disclosure;

FIG. 2 illustrates a flowchart of a video generation method provided by the embodiments of the present disclosure;

FIG. 3 illustrates a schematic diagram of a first video editing draft provided by embodiments of the present disclosure;

FIG. 4 illustrates a schematic diagram of receiving the request information sent by the terminal device provided by the embodiments of the present disclosure;

FIG. 5 illustrates a schematic diagram of replacing the path information provided by the embodiments of the present disclosure;

FIG. 6 illustrates a schematic diagram of a directory structure of a resource bundle provided by the embodiments of the present disclosure;

FIG. 7 illustrates a schematic diagram of a method for determining the first file and the second file provided by embodiments of the present disclosure;

FIG. 8 illustrates a schematic diagram of the procedure of determining the first file provided by embodiments of the present disclosure;

FIG. 9 illustrates a schematic diagram of the procedure of determining the second file provided by embodiments of the present disclosure;

FIG. 10 illustrates a structural diagram of a video generation apparatus provided by embodiments of the present disclosure;

FIG. 11 illustrates a structural diagram of an electronic device provided by the embodiments of the present disclosure.

### DETAILED DESCRIPTION OF EMBODIMENTS

Example embodiments are to be described in details below and the examples thereof are demonstrated in the drawings. In case that reference is made to the drawings in the following description, same number in different drawings represents same or similar elements unless indicated otherwise. Implementations described in the example embodiments below do not represent all implementations consistent with the present disclosure. On the contrary, the described implementations are just examples of apparatuses and methods that are elaborated in the attached claims and consistent with some aspects of the present disclosure.

It is to be appreciated that prior to the use of the technical solutions disclosed by various embodiments of the present disclosure, type, usage scope and application scenario of personal information involved in the present disclosure are made known to users through suitable ways according to the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, according to the prompt message, whether to provide their personal information to software or hardware that performs operations of the technical solution, such as electronic device, application program, server or storage medium.

As an alternative yet non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

For a better understanding of the present disclosure, concepts involved in the embodiments of the present disclosure are explained below.

A terminal device is a device with wireless transceiving function. The terminal device may be deployed on land, including indoor, outdoor, hand-held, wearable or vehicle-mounted devices. The terminal device may be mobile phone, Pad, computer with wireless transceiving function, Virtual Reality (VR) terminal device, Augmented Reality (AR) terminal device, wireless terminal in industrial control, onboard terminal device, wireless terminal in self driving, wireless terminal device in remote medical treatment, wireless terminal device in smart grid, wireless terminal device in transport safety, wireless terminal device in smart city, wireless terminal device in smart home and wearable terminal device etc. The terminal device involved in the embodiments of the present disclosure also may be referred to as terminal, user equipment (UE), access terminal device, onboard terminal, industrial control terminal, UE unit, UE station, mobile station, remote station, remote terminal device, mobile device, UE terminal device, wireless communication device, UE agent or UE apparatus etc. The terminal device may be fixed or mobile.

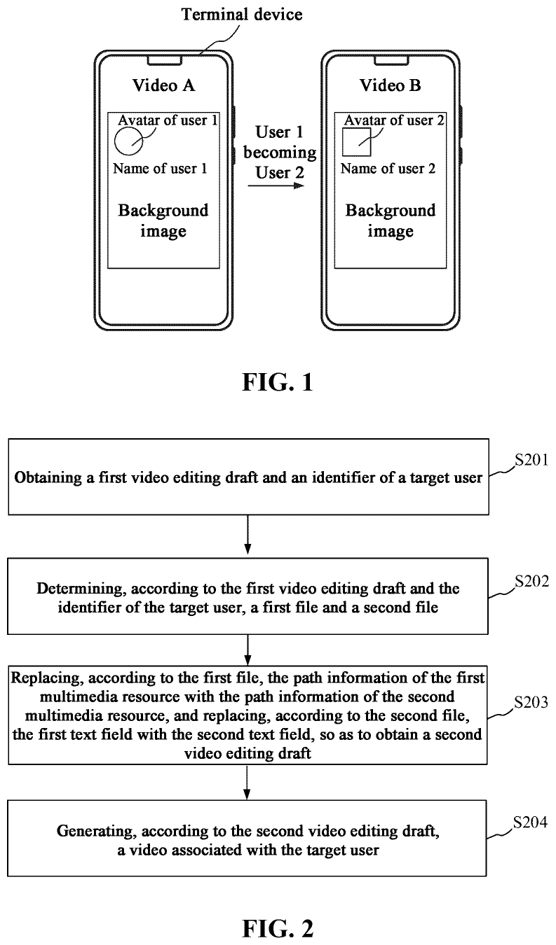

With reference to FIG. 1, application scenarios of the embodiments of the present disclosure are explained below.

FIG. 1 illustrates a schematic diagram of an application scenario provided by embodiments of the present disclosure. FIG. 1 demonstrates a terminal device, wherein a display page of the terminal device may be a video A associated with a user 1. The video A may include a background image, an avatar of the user 1 and a name of the user 1. In case of changing from the user 1 to a user 2, the terminal device may obtain from a server (not shown in FIG. 1) a video B and display the video B. The video B may include a background image (unchanged), an avatar of the user 2 and a name of the user 2. Accordingly, multimedia resources and text information in videos generated for different users also vary, so as to improve display effects of the videos.

It is to be explained that FIG. 1 is just an example of the application scenarios of the embodiments of the present disclosure and does not restrict the application scenarios of the embodiments of the present disclosure.

In the related art, a file may include parameters describing video editing and path information corresponding to multimedia information used in video editing. The terminal device may obtain an edited video through the file. For example, a json file may include video editing parameters such as special effects and filters of video editing; and if the multimedia resource corresponding to the video editing is video, the json file may include a path (through which the video is obtained) corresponding to the video. Accordingly, the terminal device may export the related video through the json file. At present, the file including video editing parameters may be generated by manual editing. For example, the user may edit one json file and the file may consist of user-designed video editing parameters. However, when the multimedia information corresponding to the video editing parameters in the file changes, for example, in case of changes of the information in the file (such as changes of multimedia resources used by video editing), the user needs to re-edit the file and the generation of the video becomes more complicated.

To solve the technical problem in the related art, the present disclosure provides a video generation method, an apparatus, and an electronic device, for solving the technical problem of the highly complicated video generation in the prior art. For example, embodiments of the present disclosure provide a video generation method. The electronic device may receive request information sent by a terminal device, and the request information may include a video type requested to be edited and an identifier of the user triggering the request information. The electronic device may determine a first video editing draft according to the video type requested to be edited and determine the identifier of the user triggering the request information as an identifier of a target user. The electronic device may determine a first file and a second file according to the first video editing draft and the identifier of the target user, replace path information of a first multimedia resource with path information of a second multimedia resource based on the first file, and replace a first text field with a second text field based on the second file to obtain a second video editing draft. The electronic device may generate, according to the second video editing draft, a video related to the target user. In the above method, since the electronic device may replace the information in the first video editing draft via the first file and the second file and further obtain the video associated with the target user, the electronic device is only required to re-acquire the first file and the second file corresponding to the target user when the target user changes. The video associated with the target user is accordingly obtained. The video generation is less complicated and more efficiency by virtue of the multiplexing of the first video editing draft. In addition, when the target user sends a change that causes the multimedia information and text information of the video editing to vary, the electronic device may multiplex the first video editing draft to generate a video related to a changed target user without requiring manual re-editing of the related file. Therefore, the complexity for video generation is reduced and the efficiency for video generation is enhanced.

The technical solution of the present disclosure and how the technical solution of the present disclosure solves the above technical problem are to be described in details below with reference to the specific embodiments. The following specific embodiments may be combined with each other, and the same or similar concepts or procedures may not be elaborated in some embodiments to avoid repetition. Embodiments of the present disclosure are to be described below with reference to the drawings.

FIG. 2 illustrates a flowchart of a video generation method provided by the embodiments of the present disclosure. With reference to FIG. 2, the method may include:
S201: obtaining a first video editing draft and an identifier of a target user.

The execution body of the embodiments of the present disclosure may be an electronic device, or a video generation apparatus disposed in the electronic device, wherein the video generation apparatus may be implemented by software or a combination of software and hardware. Embodiments of the present disclosure are not restricted in this regard. Alternatively, the electronic device may be any device having computing power on terminal (such as server and computer etc.). Embodiments of the present disclosure are not restricted in this regard.

Wherein the first video editing draft may be used to indicate a video editing scheme. For example, the first video editing draft may include path information of multimedia resources required by video editing, starting and ending time of video editing, and special effects corresponding to each multimedia resource etc. For example, the first video editing draft may be a file in json format, and the file may include path information of video materials, special effects parameters used by the video materials, starting and ending time of the special effects parameters and play rate of the video materials etc. The electronic device may export the related video through the file in json format.

Wherein the first video editing draft may include path information of a first multimedia resource and a first text field for video editing. For example, the first multimedia resource may be a variable multimedia resource in the first video editing draft, and the first video editing draft may store path information of the first multimedia resource. When generating the video, the electronic device may obtain the first multimedia resource through the path information. For example, the first multimedia resource may be video material, audio material and image material etc. Embodiments of the present disclosure are not restricted in this regard.

Alternatively, the first video editing draft may include variable multimedia resources and non-variable multimedia resources. For example, in the first video editing draft, image 1 is a variable multimedia resource (first multimedia resource) and image 2 is a non-variable multimedia resource. In such case, when the electronic device generates the video, the image 1 in the video is non-replaceable and the image 2 in the video is replaceable.

Alternatively, the electronic device may determine whether the multimedia resource can be changed according to a mark of the path information of the multimedia resources in the first video editing draft. For example, in case that the image 1 is variable and the image 2 is non-variable in the first video editing draft, the path information of the image 1 may be labeled as variable path information and the path information of the image 2 may be labeled as non-variable path information.

Wherein a first text field is used for video editing. For example, the first text field may include a field name and a field value, wherein the field name may indicate a text type included in the first video editing draft. For example, the name of the user may be displayed in the video generated by the electronic device. Accordingly, in the first video editing draft, the field name of the first text field may be a name and the field value of the first text field may be a placeholder (which may be replaced by the name of the user after the electronic device determines the name of the user).

Wherein the first text field may be a variable text field in the first video editing draft. For example, the field name in the first text field is non-variable, but the field value in the first text field can be variable. For instance, the field name of the first text field may be user name. As such, the field value of the first text field also changes when the user varies.

Alternatively, the first video editing draft may include a static text field. For example, the first video editing draft may include a text field with non-variable field value. For instance, the first text field may be a rich text. Accordingly, the field value of the first text field may change, but text fields, such as position, color and size corresponding to the rich text, are non-variable. In such case, the content of the rich text may be variable, but its position, color and size are non-variable.

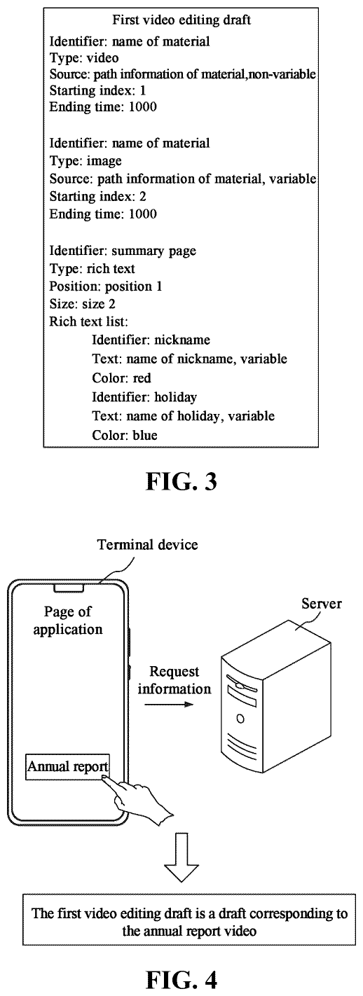

Next, the first video editing draft is described in details with reference to FIG. 3.

FIG. 3 is a schematic diagram of a first video editing draft provided by embodiments of the present disclosure. FIG. 3 demonstrates the first video editing draft, wherein the first video editing draft may include video information, image information and a plurality of text fields related to the rich text. The video information may include: (identifier: material name), (type: video), (source: path information of material, non-variable) (the path information of the video in the first video editing draft could not be changed and the video could not be replaced), (starting index: 1 (first material)) and (ending time: 1000) (which may be placeholder).

Referring to FIG. 3, the image information may include: (identifier: material name), (type: image), (source: path information of material, variable) (the path information of the image in the first video editing draft may be changed and the image may be replaced), (starting index: 2) and (ending time: 1000). The plurality of text fields associated with the rich text may include identifier, type, position, size and rich text list, wherein field values of identifier, type, position and size cannot be changed.

As shown in FIG. 3, the field values of a plurality of text fields included in the rich text list are variable. The rich text list may include: (identifier: nickname), (text: nickname, variable), (color: red), (identifier: holiday), (text: holiday name, variable) and (color: blue). That is, in the rich text list, the field name of the first text field is text and the field value of the first text field is variable (e.g., the nickname differs for various users and the holiday name changes along with the holiday), wherein the identifier and the color are non-variable text fields in the rich text list. Therefore, in case of generating a video of the same type, the electronic device may multiplex the first video editing draft to enhance the efficiency of video generation.

Wherein the target user may be a user who requests for generating a video. The electronic device may obtain the first video editing draft and the identifier of the target user through the following ways of: receiving request information sent by a terminal device, wherein the request information comprises a video type requested to be edited and an identifier of a user triggering the request information. The electronic device may determine, according to the video type requested to be edited, the first video editing draft and determine the identifier of the user triggering the request information as the identifier of the target user. Accordingly, the electronic device may accurately determine the first video editing draft and the identifier of the target user, so as to improve the accuracy of the generated target user-related video.

For example, an application page may include a video generation control. When the user clicks the control, the terminal device may generate request information and send the it to the server. The video type in the request information may be a video type corresponding to the video generation control. The identifier of the user triggering the request information may be an identifier of the user logging in the application.

Alternatively, the electronic device may obtain a corresponding relation between the video type and the video editing draft, and determine the first video editing draft according to the video type requested to be edited and the corresponding relation. For example, the corresponding relation between the video type and the video editing draft may be shown in Table 1 below:

TABLE 1

| Video Type | Video Editing Draft |
|---|---|
| Type 1 | Draft 1 |
| Type 2 | Draft 2 |
| Type 3 | Draft 3 |
| . . . | . . . |

It is to be explained that Table 1 is an example of the corresponding relation between the video type and the video editing draft, rather than a limitation of such corresponding relation.

For example, if the video type requested to be edited is Type 1, the electronic device may determine the first video editing draft as Draft 1; if the video type requested to be edited is Type 2, the electronic device may determine the first video editing draft as Draft 2; if the video type requested to be edited is Type 3, the electronic device may determine the first video editing draft as Draft 3.

Next, a procedure of receiving the request information sent by the terminal device is to be explained with reference to FIG. 4.

FIG. 4 is a schematic diagram of receiving the request information sent by the terminal device provided by the embodiments of the present disclosure. FIG. 4 demonstrates the terminal device and the server, wherein the display page of the terminal device is an application page including an annual report control. When the user clicks the annual report control, the terminal device may send the request information to the server, wherein the request information may include a video (the user using the annual report of the application) type of an annual report and an identifier of the user logging in the application. The server may determine, according to the request information, the first video editing draft as a draft corresponding to the annual report video and determine the identifier of the user logging in the application as the identifier of the target user.
S202: determining a first file and a second file according to the first video editing draft and the identifier of the target user.

Wherein the first file may include path information of the second multimedia resource associated with the target user. For example, the second multimedia resource may be an avatar, a video or an image published by the target user. Embodiments of the present disclosure are not restricted in this regard.

Wherein the second file may include a second text field associated with the target user. For example, the second text field may include a user nickname (field value) or a name (field value) of a purchased article published by the user and the like. For instance, the second text field may be (name: nickname (nickname published by the target user)), where name is a field name of the second text field and the nickname may be a field value of the second text field.

For example, if the first video editing draft is a draft of the annual report video, the electronic device may obtain the path information of the avatar published by the target user required by the annual report video and the text information (e.g., nickname published by the target user and the like) of the target user required by the annual report video according to the identifier of the target user. In such case, the first file may include the path information of the avatar published by the target user and the second file may include the text information of the target user.
S203: replacing the path information of the first multimedia resource with the path information of the second multimedia resource according to the first file and replacing, according to the second file, the first text field with the second text field, to obtain a second video editing draft.

Wherein for any second multimedia resource in the first file, the electronic device may replace the path information of the first multimedia resource with the path information of the second multimedia resource through the following feasible ways of: obtaining the identifier of the second multimedia resource; determining a target multimedia resource in the first multimedia resource according to the identifier of the second multimedia resource; and replacing the path information of the target multimedia resource with the path information of the second multimedia resource in the first video editing draft. Accordingly, the electronic device may accurately replace the variable first multimedia resource in the first video draft with the second multimedia resource associated with the target user, so as to enhance the video accuracy.

Wherein the identifier of the target multimedia resource is the same as the identifier of the second multimedia resource. For example, the identifier of the second multimedia resource is the avatar. If a plurality of multimedia resources in the first video editing draft includes the first multimedia resource with an identifier of avatar, the electronic device may determine the first multimedia resource with an identifier of avatar as the target multimedia resource.

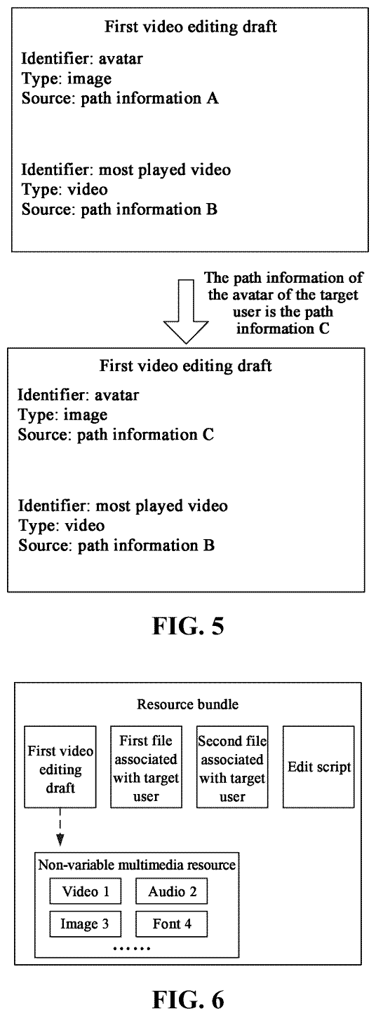

Next, a procedure of replacing the path information of the first multimedia resource by the electronic device is described with reference to FIG. 5.

FIG. 5 illustrates a schematic diagram of replacing the path information provided by the embodiments of the present disclosure. FIG. 5 demonstrates the first video editing draft, which includes the path information A of the avatar and the path information B of the most played video. If the path information of the avatar of the target user is the path information C, the electronic device (not shown in FIG. 5) may replace the path information A corresponding to the avatar in the first video editing draft 1 with the path information C.

It is to be appreciated that FIG. 5 is just an example of the first video editing draft, rather than a limitation to it.

Wherein the electronic device may replace the first text field with the second text field by the following feasible ways of: obtaining an edit script corresponding to the first video editing draft and replacing the first text field with the second text field according to the edit script and the second text.

Wherein the edit script may be used for processing the first text field and the second text field. For example, when running the edit script, the electronic device may assign the field value of the second text field to the field value of the first text field. For instance, the edit script may replace the field value (which may be placeholder) of the name field (first text field) in the first video editing draft with the field value (nickname published by the target user) of the name field (second text field) in the second file.

Wherein, for any second text field in the second file, the electronic device replaces, according to the edit script and the second file, the first text field with the second text field. Specifically, an assignment function unit corresponding to the second text field is determined in the edit script according to the field name of the second text field; and the field value of the target text field in the first video editing draft is replaced by the field value of the second text field based on the assignment function unit. Accordingly, the electronic device may accurately replace the field value of the first text field in the first video editing draft with the information related to the target user, to further enhance the video accuracy.

Wherein the target text field may be the first text field having the same field name as the second text field. For example, the field name of the first text field 1 is name and the field name of the first text field 2 is holiday. If the field name of the second text field is name, the electronic device may determine the first text field 1 as the target text field.

Wherein the edit script may include a plurality of assignment function units, and each assignment function unit may assign the field value of the second text field to the field value of the first text field corresponding to the second text field. For example, the edit script may include an assignment function unit 1 and an assignment function unit 2. The assignment function unit 1 may replace the field value (which may be placeholder) of the name field (first text field) in the first video editing draft with the field value (nickname published by the target user) of the name field (second text field) in the second file and the assignment function unit 2 may replace the field value of the holiday field in the first video editing draft with the field value of the holiday field in the second file.

Alternatively, the assignment function unit corresponding to the second text field includes the field name of the second text field. For example, the assignment function unit may include a plurality of segments of codes; if a plurality of segments of codes of the assignment function unit includes the field name of the second text field, the assignment function unit is the assignment function unit corresponding to the second text field. For instance, the codes in the assignment function unit 1 include name and the codes in the assignment function unit 2 include holiday; if the field name of the second text field is name, the electronic device may determine the assignment function unit 1 to be the assignment function unit corresponding to the second text field.

Alternatively, the electronic device replaces, according to the assignment function unit, the field value of the target text field in the first video editing draft with the field value of the second text field. Specifically, the electronic device determines, according to the assignment function unit, an assignment position of the target text field and replaces the field value of the assignment position with the field value of the second text field.

Wherein the assignment function unit may alter the field value of the first text field in the first video editing draft in a way consistent with service logic. As such, the assignment function unit may include the assignment position. For example, with reference to FIG. 3, if the field name of the first text field of the target user is nickname and its field value is the nickname published by the target user, the electronic device may determine to replace field values of the text fields of the rich text list in the first video editing draft. Since the rich text list may include a plurality of text fields, the electronic device may determine, according to the assignment function unit, the assignment position (field value of the text under the identifier of nickname in the rich text list) corresponding to the nickname and replace the field value of the assignment position with the nickname published by the target user.

Wherein the electronic device may obtain the second video editing drafty by replacing the path information of the first multimedia resource with the path information of the second multimedia resource via the first file, and replacing the first text field with the second text field via the second file.

Alternatively, in practical applications, part of the second text field in the second file may lack related field value. Accordingly, the electronic device may keep the field value of the target text field corresponding to the second text field in the first video editing draft. For example, the field value of the name of the first purchased article (field name of the first text field) in the first video editing draft is toothbrush by default. If the target user never purchases an article in the application, the name of the first purchased article (field name of the second text field) is empty in the second file corresponding to the target user. Therefore, the electronic device would not replace the field value of the name of the first purchased article in the first video editing draft, and the field value of the name of the first purchased article may be toothbrush in the second video editing draft determined by the electronic device.
S204: generating, according to the second video editing draft, a video associated with the target user.

Alternatively, the electronic device may load the second video editing draft to obtain the video associated with the target user. For example, if the first video editing draft is the annual report video with respect to usage of the application, the electronic device may obtain the annual report video associated with the target user after loading the second video editing draft corresponding to the first video editing draft, wherein the annual report video may include multimedia resources and text information of the target user.

Alternatively, the first video editing draft, the first file and the second file may all be in json format, and the edit script may be Python script. Next, a directory structure of a resource bundle according to embodiments of the present disclosure is described with reference to FIG. 6.

FIG. 6 illustrates a schematic diagram of a directory structure of a resource bundle provided by the embodiments of the present disclosure. FIG. 6 demonstrates the resource bundle, wherein the resource bundle may include the first video editing draft, the first file associated with the target user, the second file associated with the target user and the edit script. The first video editing draft may include path information of the non-variable multimedia resource and path information of the variable first multimedia resource (which may be placeholder), wherein the non-variable multimedia resource may include video 1, audio 2, image 3, font 4 and the like. The electronic device (not shown in FIG. 6) may load the resource bundle to obtain the video associated with the target user.

Alternatively, the electronic device may generate the first video editing draft. For example, the electronic device may obtain an annual report video; the electronic device may build an editing model based on parameters (as shown in Tables 2 and 3) of the first video editing draft and adjust video materials and image display effects in the annual report video; the electronic device may label part of the downloadable resources (such as first multimedia resource and first text field etc.) to be dynamically replaced as variable and pack the edit file and the related multimedia resources and text fields, to obtain the first video editing draft; besides, after obtaining the first video editing draft, the electronic device also may design the second file according to the first video editing draft and supplement logic of the edit script.

Embodiments of the present disclosure provide a video generation method. The electronic device receives the request information sent by the terminal device. The electronic device may determine the first video editing draft according to the video type requested to be edited in the request information and determine the identifier of the user triggering the request information as the identifier of the target user. The electronic device determines the first file and the second file according to the first video editing draft and the identifier of the target user, replaces the path information of the first multimedia resource with the path information of the second multimedia resource based on the first file, and replaces, according to the second file, the first text field with the second text field, so as to obtain the second video editing draft. The electronic device generates, according to the second video editing draft, the video associated with the target user. Accordingly, the electronic device may multiplex the first video editing draft according to the first file and the second file associated with the target user to generate a video related to a changed target user, so as to reduce the complexity for video generation and enhance the efficiency for video generation.

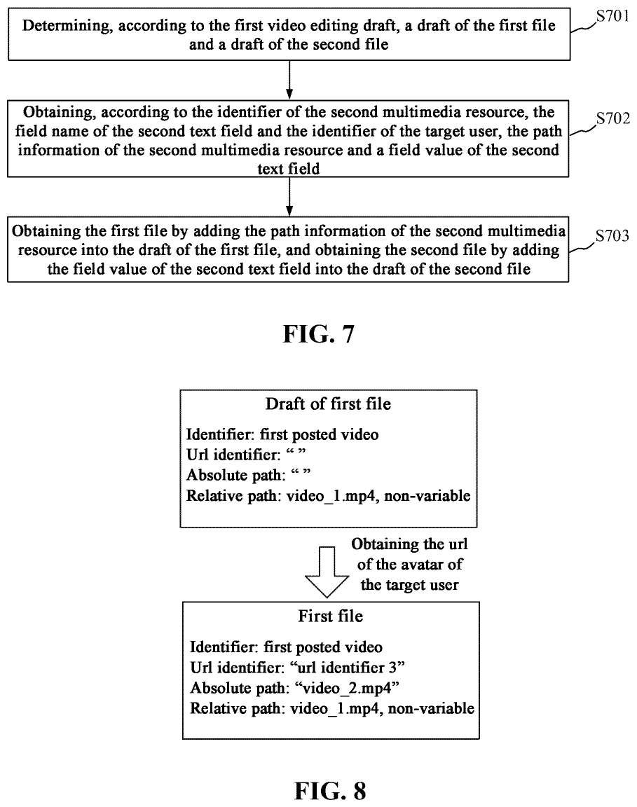

On the basis of the embodiment shown in FIG. 2, the determination of the first file and the second file according to the first video editing draft and the identifier of the target user in the above video generation method is to be explained below with reference to FIG. 7.

FIG. 7 illustrates a schematic diagram of a method for determining the first file and the second file provided by embodiments of the present disclosure. According to FIG. 7, the method procedure may include:
S701: determining a draft of the first file and a draft of a second file according to the first video editing draft.

Wherein the draft of the first file may include an identifier of the second multimedia resource. For example, the draft of the first file may include an identifier of user avatar and an identifier of a first video posted by the user etc.

Alternatively, the electronic device may determine the draft of the first file according to the identifier of the first multimedia resource in the first video editing draft. For example, the identifier of the second multimedia resource in the draft of the first file may be the same as the identifier of the first multimedia resource in the first video editing draft. For example, if the first multimedia resource includes the user avatar and the first video posted by the user in the first video editing draft, the draft of the first file corresponding to the first video editing draft may include the identifier of the user avatar and the identifier of the first video posted by the user.

Alternatively, the electronic device may determine the draft of the first file corresponding to the first video editing draft based on a preset first corresponding relation. For example, the first corresponding relation may include at least one first video editing draft and the draft of the first file corresponding to each first video editing draft.

Next, the protocol of the first multimedia resource or the second multimedia resource in the resource pool is to be explained with reference to Table 2.

TABLE 2

| Parameter name | Type | Mandatory or not | Default value | Meaning |
|---|---|---|---|---|
| id | string | YES | Null | Multimedia resource id |
| | | | | identifier |
| schema | string | YES | “” | Remote resource identifier |
| | | | | url/uri |
| local_path | string | YES | “” | Absolute path |
| | | | | corresponding to |
| | | | | downloaded remote |
| | | | | resource |
| default_path | string | YES | “” | Relative path of default |
| | | | | resource |
| algorithm key | string | NO | Null | Algorithm link |
| and parameter | string | NO | Null | Algorithm parameter |

Wherein the first video editing draft or the first file may include id, schema, local_path and default_path, as well as algorithm key and parameter. For example, id may represent identifier of the multimedia resource. For instance, schema may be url of the multimedia resource; the electronic device may obtain the url based on the identifier of the target user and download the related second multimedia resource on the basis of the url, so as to obtain the absolute path of the second multimedia resource. In case of not obtaining the url of the second multimedia resource corresponding to the target user, the electronic device may obtain the relative path of the default resource, wherein the default resource may be the first multimedia resource. For example, when the multimedia resource is an image, the algorithm may be a super-resolution algorithm, and the first video editing draft or the first file may include the link and the parameters of the super-resolution algorithm (such as doubling the resolution etc.).

Wherein the draft of the second file may include the field name of the second text field. For example, the draft of the second file may include user nickname and the name of article purchased by the user for the first time etc. Embodiments of the present disclosure are not restricted in this regard.

Alternatively, the electronic device may determine the draft of the second file according to the field name of the first text field in the first video editing draft. For example, the field name of the second text field in the draft of the first file may be the same as the field name of the first text field in the first video editing draft. For example, if the field name of the first text field in the first video editing draft includes name, article and holiday, the draft of the second file corresponding to the first video editing draft may include name, article and holiday.

Wherein since the field value of the text field may be in rich text format (e.g., the user nickname may be displayed in bold), the text field of the rich text is to be explained in details below with reference to Table 3.

TABLE 3

| Name | Type | Mandatory or not | Default value | Explanation |
|---|---|---|---|---|
| Type | String | YES | rich_text | Element type |
| | | | | being ‘rich- |
| | | | | text’ |
| RichTextList | List<RichTextInfo> | YES | | Rich text |
| | | | | content |
| StartOffset | Int32 | NO | 0 | Starting time |
| EndOffset | Int32 | YES | | Ending time |
| StartIndex | Int32 | YES | | Play starting |
| | | | | from video |
| | | | | index and the |
| | | | | first video |
| | | | | index being 0 |
| EndIndex | Int32 | YEW | | Play ending at |
| | | | | video index |
| OffsetX | Float | NO | 0 | Normalized |
| | | | | coordinate x |
| OffsetY | Float | NO | 0 | Normalized |
| | | | | coordinate y |
| AnchorX | Float | NO | 0 | Anchor |
| | | | | coordinate x |
| | | | | [−1, 1] |
| AnchorY | Float | NO | 0 | Anchor |
| | | | | coordinate y |
| | | | | [−1, 1] |
| Scale | Float | NO | 1 | Proportional |
| | | | | scale |
| Alpha | Float | NO | 1 | Overall |
| | | | | transparency of |
| | | | | sticker [0, 1] |
| Rotate | Int32 | NO | 0 | Rotating angle |
| | | | | of material [0, |
| | | | | 360] |
| FlipX | Int32 | NO | 0 | Horizontal flip |
| FlipY | Int32 | NO | 0 | Vertical flip |
| BoldWidth | Float | NO | 0 | Bold degree |
| | | | | 0~0.05 |
| ItalicDegree | Int32 | NO | 0 | Italic degree |
| DecorationWidth | Float | NO | 0 | Underline |
| | | | | width |
| DecorationOffset | Float | NO | 0 | Underline |
| | | | | offset |
| CanvasColor | String | NO | “” | Overall |
| | | | | background |
| | | | | color of sticker |

It is to be explained that Table 3 is an example of the text field, rather than a limitation to it. Besides, the text field of the rich text also may include any other text fields (such as word space, line spacing and color etc.). Embodiments of the present disclosure are not restricted in this regard.
S702: obtaining the path information of the second multimedia resource and the field value of the second text field according to the identifier of the second multimedia resource, the field name of the second text field and the identifier of the target user.

Alternatively, the electronic device may determine the URL of the second multimedia resource according to the identifier of the target user and the identifier of the second multimedia resource and further determine the path information of the second multimedia resource based on the URL. For example, if the identifier of the second multimedia resource is avatar, the electronic device may obtain the URL of the avatar of the target user from a database and download the avatar of the target user according to the URL to obtain the path information of the avatar of the target user.

Alternatively, the electronic device may obtain the field value of the second text field according to the identifier of the target user and the field name of the second text field. For example, if the field name of the second text field is name, the electronic device may obtain the nickname of the target user from the database; if the second text field is the first purchased article, the electronic device may obtain the name of the first purchased article of the target user from the database.
S703: adding the path information of the second multimedia resource into the draft of the first file to obtain the first file; and adding the field value of the second text field into the draft of the second file to obtain the second file.

Wherein after obtaining the path information of the second multimedia resource, the electronic device may add the second path information into the draft of the first file. For example, subsequent to obtaining the path information of the avatar of the target user, the electronic device may add the path information of the avatar of the target user at a position related to avatar identifier in the draft of the first file.

The procedure of determining the first file is to be described below with reference to FIG. 8.

FIG. 8 illustrates a schematic diagram of the procedure of determining the first file provided by embodiments of the present disclosure. FIG. 8 demonstrates the draft of the first file, in which the identifier of the second multimedia resource is avatar, the url identifier is empty, the absolute path is empty, and the relative path is video_1.mp4 and non-variable. The electronic device (not shown in FIG. 8) may obtain the url of the avatar of the target user (url identifier 3) and download the avatar according to the url, to obtain the absolute path of the avatar (path information) and further acquire the first file, wherein the url identifier in the first file is url identifier 3 and the absolute path is video_2.mp4.

Wherein after obtaining the field value of the second text field, the electronic device may add the field value into the draft of the second file. For example, subsequent to obtaining the nickname of the target user, the electronic device may add the nickname of the target user into the name in the draft of the second file.

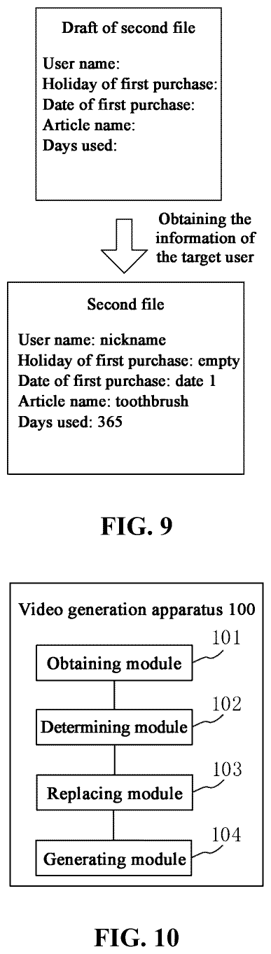

The procedure of determining the second file is to be described below with reference to FIG. 9.

FIG. 9 illustrates a schematic diagram of the procedure of determining the second file provided by embodiments of the present disclosure. FIG. 9 demonstrates the draft of the second file, in which the field name of the second text field includes: user name, holiday of the first purchase, date of the first purchase, article name and days used.

According to FIG. 9, the electronic device (not shown in FIG. 9) may obtain the information related to the target user according to the identifier of the target user and the field name of the second text field, and add the information into the draft of the second file, so as to obtain the second file. The second text field in the second file includes: (user name: nickname), (holiday of first purchase: null), (date of first purchase: date 1), (article name: toothbrush) and (days used: 365). Accordingly, the electronic device may accurately obtain the second file, to further enhance the accuracy for video generation.

It is to be explained that the holiday of the first purchase and the date of the first purchase in the second file are the second text fields of the same type. As such, if the field value of the holiday of the first purchase is spring festival and the date of the first purchase is the date of the spring festival, the electronic device may display, based on the edit script, “holiday of first purchase: spring festival” in the video related to the target user, wherein the priority of the holiday of first purchase is higher than that of the date of the first purchase, which may be configured via the edit script. For example, the editing of the edit script may be: if the holiday of first purchase in the second file includes a valid field value (i.e., the date of first purchase also includes valid field value), the video of the target user displays a page corresponding to the holiday of the first purchase. The page includes the holiday of first purchase: rich text of spring festival and does not contain the rich text of the date of first purchase.

Embodiments of the present disclosure provide a method for determining the first file and the second file. The electronic device may determine the draft of the first file and the draft of the second file according to the first video editing draft, and obtain the path information of the second multimedia resource and the field value of the second text field based on the identifier of the second multimedia resource, the field name of the second text field and the identifier of the target user. The electronic device obtains the first file by adding the path information of the second multimedia resource into the draft of the first file and obtains the second file by adding the field value of the second text field into the draft of the second file. Accordingly, the electronic device may accurately obtain the first file and the second file and further enhance the accuracy of the video of the target user.

FIG. 10 illustrates a structural diagram of a video generation apparatus provided by embodiments of the present disclosure. The video generation apparatus 100 comprises an obtaining module 101, a determining module 102, a replacing module 103 and a generating module 104, wherein:

The obtaining module 101 is provided for obtaining a first video editing draft and an identifier of a target user, wherein the first video editing draft includes path information of a first multimedia resource and a first text field for video editing;

The determining module 102 is provided for determining, according to the first video editing draft and the identifier of the target user, a first file including path information of a second multimedia resource associated with the target user and a second file including a second text field associated with the target user;

The replacing module 103 is provided for replacing, according to the first file, the path information of the first multimedia resource with the path information of the second multimedia resource, and replacing, according to the second file, the first text field with the second text field, so as to obtain a second video editing draft;

The generating module 104 is provided for generating, according to the second video editing draft, a video associated with the target user.

In accordance with one or more embodiments of the present disclosure, the replacing module 103 is specifically provided for:
obtaining an identifier of the second multimedia resource;
determining, according to the identifier of the second multimedia resource, a target multimedia resource in the first multimedia resource, wherein an identifier of the target multimedia resource is the same as the identifier of the second multimedia resource;
replacing, in the first video editing draft, path information of the target multimedia resource with the path information of the second multimedia resource.

In accordance with one or more embodiments of the present disclosure, the replacing module 103 is specifically provided for:
obtaining an edit script corresponding to the first video editing draft, wherein the edit script is used for processing the first text field and the second text field;
replacing, according to the edit script and the second file, the first text field with the second text field.

In accordance with one or more embodiments of the present disclosure, the replacing module 103 is specifically provided for:
determining, according to a field name of the second text field and in the edit script, an assignment function unit corresponding to the second text field;
replacing, according to the assignment function unit, a field value of a target text field in the first video editing draft with a field value of the second text field;
wherein the target text field is a first text field having a field name the same as that of the second text field.

In accordance with one or more embodiments of the present disclosure, the replacing module 103 is specifically provided for:
determining, according to the assignment function unit, an assignment position of the target text field;
replacing a field value of the assignment position with the field value of the second text field.

In accordance with one or more embodiments of the present disclosure, the obtaining module 101 is specifically provided for:
receiving request information sent by a terminal device, wherein the request information comprises a video type requested to be edited and an identifier of a user triggering the request information;
determining, according to the video type requested to be edited, the first video editing draft and determining the identifier of the user triggering the request information as the identifier of the target user.

In accordance with one or more embodiments of the present disclosure, the determining module 102 is specifically provided for:
determining, according to the first video editing draft, a draft of the first file including an identifier of the second multimedia resource and a draft of the second file including a field name of the second text field;
obtaining, according to the identifier of the second multimedia resource, the field name of the second text field and the identifier of the target user, the path information of the second multimedia resource and a field value of the second text field;
obtaining the first file by adding the path information of the second multimedia resource into the draft of the first file, and obtaining the second file by adding the field value of the second text field into the draft of the second file.

A video generation apparatus provided by the embodiments of the present disclosure may be applied to implement the technical solution of the above method embodiments. The implementation principle and the technical effects of the apparatus are similar to those of the method and will not be elaborated here to avoid repetition.

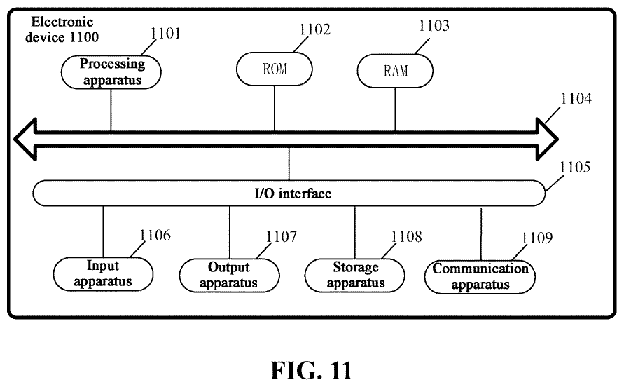

FIG. 11 illustrates a structural diagram of an electronic device provided by the embodiments of the present disclosure. With reference to FIG. 11, a structural diagram of an electronic device 1100 adapted to implement embodiments of the present disclosure is shown, wherein the electronic device may include, but not limited to, mobile terminals, such as mobile phones, notebooks, digital broadcast receivers, Personal Digital Assistant (PDA), Portable Android Device (PAD), Portable Multimedia Player (PMP) and vehicle terminals (such as car navigation terminal) and fixed terminals, e.g., digital TVs and desktop computers etc. The electronic device shown in FIG. 11 is just an example and will not put any restrictions on the functions and application ranges of the embodiments of the present disclosure.

According to FIG. 11, the electronic device 1100 may include a processing unit (e.g., central processor, graphic processor and the like) 1101, which can execute various suitable actions and processing based on the programs stored in the read-only memory (ROM) 1102 or programs loaded in the random-access memory (RAM) 1103 from a storage unit 1108. The RAM 1103 can also store all kinds of programs and data required by the operations of the electronic device 1100. Processing apparatus 1101, ROM 1102 and RAM 1103 are connected to each other via a bus 1104. The input/output (I/O) interface 1105 is also connected to the bus 1104.

Usually, input apparatus 1106 (including touch screen, touchpad, keyboard, mouse, camera, microphone, accelerometer, gyroscope and like) and output apparatus 1107 (including liquid crystal display (LCD), speaker and vibrator etc.), storage apparatus 1108 (including tape and hard disk etc.) and communication apparatus 1109 may be connected to the I/O interface 1105. The communication apparatus 1109 may allow the electronic device 1100 to exchange data with other devices through wired or wireless communications. Although FIG. 11 illustrates the electronic device 1100 having various units, it is to be understood that it is not a prerequisite to implement or provide all illustrated units. Alternatively, more or less units may be implemented or provided.

In particular, according to embodiments of the present disclosure, the process depicted above with reference to the flowchart may be implemented as computer software programs. For example, the embodiments of the present disclosure include a computer program product including computer programs carried on a computer readable medium, wherein the computer programs include program codes for executing the method demonstrated by the flowchart. In these embodiments, the computer programs may be loaded and installed from networks via the communication apparatus 1109, or installed from the storage apparatus 1108, or installed from the ROM 1102. The computer programs, when executed by the processing apparatus 1101, performs the above functions defined in the method according to the embodiments of the present disclosure.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same. In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

The above computer readable medium may be included in the aforementioned electronic device or stand-alone without fitting into the electronic device.

The above computer-readable medium carriers one or more programs, where the one or more programs, when executed by the electronic device, cause the electronic device to perform the method shown by the above embodiments.

Embodiments of the present disclosure provide a computer-readable storage medium, wherein the computer-readable storage medium is stored with computer-executable instructions; wherein the processor implements respective possible methods involved in the above embodiments when executing the computer-executable instructions.

Embodiments of the present disclosure provide a computer program product including computer programs, which computer programs, when executed by the processor, implement respective possible methods involved in the above embodiments.

Computer program instructions for executing operations of the present disclosure are written in one or more programming languages or combinations thereof. The above programming languages include object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit should not be considered as the restriction over the unit per se. For example, the first obtaining unit also may be described as “a unit that obtains at least two internet protocol addresses”.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

It is to be noted that the terms “one” and “more” disclosed in the present disclosure are exemplary rather than restrictive. Those skilled in the art should understand that the above terms are to be read as “one or more” unless indicated otherwise in the context.

Names of the messages or information exchanged between a plurality of apparatuses in the implementations of the present disclosure are provided only for explanatory purpose, rather than restricting the scope of the messages or information.

It is to be understood that data (including but not limited to the data per se and acquisition or usage of the data) involved in the technical solution should comply with corresponding laws and regulations. Data may include information, parameters and messages etc., such as traffic switching indication information.

In a first aspect, embodiments of the present disclosure provide a video generation method, comprising:
obtaining a first video editing draft and an identifier of a target user, wherein the first video editing draft includes path information of a first multimedia resource and a first text field for video editing;
determining, according to the first video editing draft and the identifier of the target user, a first file including path information of a second multimedia resource associated with the target user and a second file including a second text field associated with the target user;
replacing, according to the first file, the path information of the first multimedia resource with the path information of the second multimedia resource, and replacing, according to the second file, the first text field with the second text field, so as to obtain a second video editing draft;
generating, according to the second video editing draft, a video associated with the target user.

In accordance with one or more embodiments of the present disclosure, for any second multimedia resource in the first file, replacing, according to the first file, the path information of the first multimedia resource with the path information of the second multimedia resource comprises:
obtaining an identifier of the second multimedia resource;
determining, according to the identifier of the second multimedia resource, a target multimedia resource in the first multimedia resource, wherein an identifier of the target multimedia resource is the same as the identifier of the second multimedia resource;
replacing, in the first video editing draft, path information of the target multimedia resource with the path information of the second multimedia resource.

In accordance with one or more embodiments of the present disclosure, replacing, according to the second file, the first text field with the second text field comprises:
obtaining an edit script corresponding to the first video editing draft, wherein the edit script is used for processing the first text field and the second text field;
replacing, according to the edit script and the second file, the first text field with the second text field.

In accordance with one or more embodiments of the present disclosure, for any second text field in the second file, replacing, according to the edit script and the second file, the first text field with the second text field comprises:
determining, according to a field name of the second text field and in the edit script, an assignment function unit corresponding to the second text field;
replacing, according to the assignment function unit, a field value of a target text field in the first video editing draft with a field value of the second text field;
wherein the target text field is a first text field having a field name the same as that of the second text field.

In accordance with one or more embodiments of the present disclosure, replacing, according to the assignment function unit, the field value of the target text field in the first video editing draft with the field value of the second text field comprises:
determining, according to the assignment function unit, an assignment position of the target text field;
replacing a field value of the assignment position with the field value of the second text field.

In accordance with one or more embodiments of the present disclosure, obtaining the first video editing draft and the identifier of the target user comprises:
receiving request information sent by a terminal device, wherein the request information comprises a video type requested to be edited and an identifier of a user triggering the request information;
determining, according to the video type requested to be edited, the first video editing draft and determining the identifier of the user triggering the request information as the identifier of the target user.

In accordance with one or more embodiments of the present disclosure, determining, according to the first video editing draft and the identifier of the target user, the first file and the second file comprises:
determining, according to the first video editing draft, a draft of the first file including an identifier of the second multimedia resource and a draft of the second file including a field name of the second text field;
obtaining, according to the identifier of the second multimedia resource, the field name of the second text field and the identifier of the target user, the path information of the second multimedia resource and a field value of the second text field;
obtaining the first file by adding the path information of the second multimedia resource into the draft of the first file, and obtaining the second file by adding the field value of the second text field into the draft of the second file.

In a second aspect, embodiments of the present disclosure provide a video generation apparatus, comprising an obtaining module, a determining module, a replacing module and a generating module, wherein:
the obtaining module is provided for obtaining a first video editing draft and an identifier of a target user, wherein the first video editing draft includes path information of a first multimedia resource and a first text field for video editing;
the determining module is provided for determining, according to the first video editing draft and the identifier of the target user, a first file including path information of a second multimedia resource associated with the target user and a second file including a second text field associated with the target user;
the replacing module is provided for replacing, according to the first file, the path information of the first multimedia resource with the path information of the second multimedia resource, and replacing, according to the second file, the first text field with the second text field, so as to obtain a second video editing draft;
the generating module is provided for generating, according to the second video editing draft, a video associated with the target user.

In accordance with one or more embodiments of the present disclosure, the replacing module is specifically provided for:
obtaining an identifier of the second multimedia resource;
determining, according to the identifier of the second multimedia resource, a target multimedia resource in the first multimedia resource, wherein an identifier of the target multimedia resource is the same as the identifier of the second multimedia resource;
replacing, in the first video editing draft, path information of the target multimedia resource with the path information of the second multimedia resource.

In accordance with one or more embodiments of the present disclosure, the replacing module is specifically provided for:
obtaining an edit script corresponding to the first video editing draft, wherein the edit script is used for processing the first text field and the second text field;
replacing, according to the edit script and the second file, the first text field with the second text field.

In accordance with one or more embodiments of the present disclosure, the replacing module is specifically provided for:
determining, according to a field name of the second text field and in the edit script, an assignment function unit corresponding to the second text field;
replacing, according to the assignment function unit, a field value of a target text field in the first video editing draft with a field value of the second text field;
wherein the target text field is a first text field having a field name the same as that of the second text field.

In accordance with one or more embodiments of the present disclosure, the replacing module is specifically provided for:
determining, according to the assignment function unit, an assignment position of the target text field;
replacing a field value of the assignment position with the field value of the second text field.

In accordance with one or more embodiments of the present disclosure, the obtaining module is specifically provided for:
receiving request information sent by a terminal device, wherein the request information comprises a video type requested to be edited and an identifier of a user triggering the request information;
determining, according to the video type requested to be edited, the first video editing draft and determining the identifier of the user triggering the request information as the identifier of the target user.

In accordance with one or more embodiments of the present disclosure, the determining module is specifically provided for:
determining, according to the first video editing draft, a draft of the first file including an identifier of the second multimedia resource and a draft of the second file including a field name of the second text field;
obtaining, according to the identifier of the second multimedia resource, the field name of the second text field and the identifier of the target user, the path information of the second multimedia resource and a field value of the second text field;
obtaining the first file by adding the path information of the second multimedia resource into the draft of the first file, and obtaining the second file by adding the field value of the second text field into the draft of the second file.

In a third aspect, embodiments of the present disclosure provide a terminal device, comprising: a processor and a memory;
where the memory stores computer-executable instructions;
the processor executes the computer-executable instructions stored in the memory, such that the at least one processor performs the video generation method according to the above first aspect and various methods for image processing related to the above first aspect.

In a fourth aspect, embodiments of the present disclosure provide a computer-readable storage medium characterized in that the computer-readable storage medium is stored with computer-executable instructions, which computer-executable instructions, when executed by a processor, implement the video generation method according to the above first aspect and various methods for image processing related to the above first aspect.

The above description only explains the preferred embodiments of the present disclosure and the technical principles applied. Those skilled in the art should understand that the scope of the present disclosure is not limited to the technical solution resulted from particular combinations of the above technical features, and meanwhile should also encompass other technical solutions formed from any combinations of the above technical features or equivalent features without deviating from the above disclosed inventive concept, such as the technical solutions formed by substituting the above features with the technical features disclosed here with similar functions.

Furthermore, although the respective operations are depicted in a particular order, it should be appreciated that the operations are not required to be completed in the particular order or in succession. In some cases, multitasking or multiprocessing is also beneficial. Likewise, although the above discussion comprises some particular implementation details, they should not be interpreted as limitations over the scope of the present disclosure. Some features described separately in the context of the embodiments of the description can also be integrated and implemented in a single embodiment. Conversely, all kinds of features described in the context of a single embodiment can also be separately implemented in multiple embodiments or any suitable sub-combinations. Although the subject matter is already described by languages specific to structural features and/or method logic acts, it is to be appreciated that the subject matter defined in the attached claims is not limited to the above described particular features or acts. On the contrary, the above described particular features and acts are only example forms for implementing the claims.

I/we claim:

1. A video generation method, comprising:
obtaining a first video editing draft and an identifier of a target user, wherein the first video editing draft includes path information of a first multimedia resource and a first text field for video editing;
determining, according to the first video editing draft and the identifier of the target user, a first file including path information of a second multimedia resource associated with the target user and a second file including a second text field associated with the target user;
replacing, according to the first file, the path information of the first multimedia resource with the path information of the second multimedia resource, and replacing, according to the second file, the first text field with the second text field, so as to obtain a second video editing draft; and
generating, according to the second video editing draft, a video associated with the target user.

2. The method of claim 1, wherein for any second multimedia resource in the first file, replacing, according to the first file, the path information of the first multimedia resource with the path information of the second multimedia resource comprises:
obtaining an identifier of the second multimedia resource;
determining, according to the identifier of the second multimedia resource, a target multimedia resource in the first multimedia resource, wherein an identifier of the target multimedia resource is the same as the identifier of the second multimedia resource; and
replacing, in the first video editing draft, path information of the target multimedia resource with the path information of the second multimedia resource.

3. The method of claim 1, wherein replacing, according to the second file, the first text field with the second text field comprises:
obtaining an edit script corresponding to the first video editing draft, wherein the edit script is used for processing the first text field and the second text field; and
replacing, according to the edit script and the second file, the first text field with the second text field.

4. The method of claim 3, wherein for any second text field in the second file, replacing, according to the edit script and the second file, the first text field with the second text field comprises:
determining, according to a field name of the second text field and in the edit script, an assignment function unit corresponding to the second text field; and
replacing, according to the assignment function unit, a field value of a target text field in the first video editing draft with a field value of the second text field,
wherein the target text field is a first text field having a field name the same as that of the second text field.

5. The method of claim 4, wherein replacing, according to the assignment function unit, the field value of the target text field in the first video editing draft with the field value of the second text field comprises:
determining, according to the assignment function unit, an assignment position of the target text field; and
replacing a field value of the assignment position with the field value of the second text field.

6. The method of claim 1, wherein obtaining the first video editing draft and the identifier of the target user comprises:
receiving request information sent by a terminal device, wherein the request information comprises a video type requested to be edited and an identifier of a user triggering the request information; and
determining, according to the video type requested to be edited, the first video editing draft and determining the identifier of the user triggering the request information as the identifier of the target user.

7. The method of claim 1, wherein determining, according to the first video editing draft and the identifier of the target user, the first file and the second file comprises:
determining, according to the first video editing draft, a draft of the first file including an identifier of the second multimedia resource and a draft of the second file including a field name of the second text field;
obtaining, according to the identifier of the second multimedia resource, the field name of the second text field and the identifier of the target user, the path information of the second multimedia resource and a field value of the second text field; and
obtaining the first file by adding the path information of the second multimedia resource into the draft of the first file, and obtaining the second file by adding the field value of the second text field into the draft of the second file.

8. An electronic device comprising a processor and a memory, wherein
the memory stores computer-executable instructions; and
the processor executes the computer-executable instructions stored in the memory, so as to cause the processor to perform a video generation method comprising:
obtaining a first video editing draft and an identifier of a target user, wherein the first video editing draft includes path information of a first multimedia resource and a first text field for video editing;
determining, according to the first video editing draft and the identifier of the target user, a first file including path information of a second multimedia resource associated with the target user and a second file including a second text field associated with the target user;
replacing, according to the first file, the path information of the first multimedia resource with the path information of the second multimedia resource, and replacing, according to the second file, the first text field with the second text field, so as to obtain a second video editing draft; and
generating, according to the second video editing draft, a video associated with the target user.

9. The electronic device of claim 8, wherein for any second multimedia resource in the first file, replacing, according to the first file, the path information of the first multimedia resource with the path information of the second multimedia resource comprises:
obtaining an identifier of the second multimedia resource;
determining, according to the identifier of the second multimedia resource, a target multimedia resource in the first multimedia resource, wherein an identifier of the target multimedia resource is the same as the identifier of the second multimedia resource; and
replacing, in the first video editing draft, path information of the target multimedia resource with the path information of the second multimedia resource.

10. The electronic device of claim 8, wherein replacing, according to the second file, the first text field with the second text field comprises:
obtaining an edit script corresponding to the first video editing draft, wherein the edit script is used for processing the first text field and the second text field; and
replacing, according to the edit script and the second file, the first text field with the second text field.

11. The electronic device of claim 10, wherein for any second text field in the second file, replacing, according to the edit script and the second file, the first text field with the second text field comprises:
determining, according to a field name of the second text field and in the edit script, an assignment function unit corresponding to the second text field; and
replacing, according to the assignment function unit, a field value of a target text field in the first video editing draft with a field value of the second text field,
wherein the target text field is a first text field having a field name the same as that of the second text field.

12. The electronic device of claim 11, wherein replacing, according to the assignment function unit, the field value of the target text field in the first video editing draft with the field value of the second text field comprises:
determining, according to the assignment function unit, an assignment position of the target text field; and
replacing a field value of the assignment position with the field value of the second text field.

13. The electronic device of claim 8, wherein obtaining the first video editing draft and the identifier of the target user comprises:
receiving request information sent by a terminal device, wherein the request information comprises a video type requested to be edited and an identifier of a user triggering the request information; and
determining, according to the video type requested to be edited, the first video editing draft and determining the identifier of the user triggering the request information as the identifier of the target user.

14. The electronic device of claim 8, wherein determining, according to the first video editing draft and the identifier of the target user, the first file and the second file comprises:
determining, according to the first video editing draft, a draft of the first file including an identifier of the second multimedia resource and a draft of the second file including a field name of the second text field;
obtaining, according to the identifier of the second multimedia resource, the field name of the second text field and the identifier of the target user, the path information of the second multimedia resource and a field value of the second text field; and
obtaining the first file by adding the path information of the second multimedia resource into the draft of the first file, and obtaining the second file by adding the field value of the second text field into the draft of the second file.

15. A non-transitory computer-readable storage medium, wherein the computer-readable storage medium stores computer-executable instructions, and a processor, when executing the computer-executable instructions, implements a video generation method comprising:
obtaining a first video editing draft and an identifier of a target user, wherein the first video editing draft includes path information of a first multimedia resource and a first text field for video editing;
determining, according to the first video editing draft and the identifier of the target user, a first file including path information of a second multimedia resource associated with the target user and a second file including a second text field associated with the target user;
replacing, according to the first file, the path information of the first multimedia resource with the path information of the second multimedia resource, and replacing, according to the second file, the first text field with the second text field, so as to obtain a second video editing draft; and
generating, according to the second video editing draft, a video associated with the target user.

16. The non-transitory computer-readable storage medium of claim 15, wherein for any second multimedia resource in the first file, replacing, according to the first file, the path information of the first multimedia resource with the path information of the second multimedia resource comprises:
obtaining an identifier of the second multimedia resource;
determining, according to the identifier of the second multimedia resource, a target multimedia resource in the first multimedia resource, wherein an identifier of the target multimedia resource is the same as the identifier of the second multimedia resource; and
replacing, in the first video editing draft, path information of the target multimedia resource with the path information of the second multimedia resource.

17. The non-transitory computer-readable storage medium of claim 15, wherein replacing, according to the second file, the first text field with the second text field comprises:
obtaining an edit script corresponding to the first video editing draft, wherein the edit script is used for processing the first text field and the second text field; and
replacing, according to the edit script and the second file, the first text field with the second text field.

18. The non-transitory computer-readable storage medium of claim 17, wherein for any second text field in the second file, replacing, according to the edit script and the second file, the first text field with the second text field comprises:
determining, according to a field name of the second text field and in the edit script, an assignment function unit corresponding to the second text field; and
replacing, according to the assignment function unit, a field value of a target text field in the first video editing draft with a field value of the second text field,
wherein the target text field is a first text field having a field name the same as that of the second text field.

19. The non-transitory computer-readable storage medium of claim 18, wherein replacing, according to the assignment function unit, the field value of the target text field in the first video editing draft with the field value of the second text field comprises:
determining, according to the assignment function unit, an assignment position of the target text field; and
replacing a field value of the assignment position with the field value of the second text field.

20. The non-transitory computer-readable storage medium of claim 15, wherein obtaining the first video editing draft and the identifier of the target user comprises:
receiving request information sent by a terminal device, wherein the request information comprises a video type requested to be edited and an identifier of a user triggering the request information; and
determining, according to the video type requested to be edited, the first video editing draft and determining the identifier of the user triggering the request information as the identifier of the target user.
